(19) United States
(12) Patent Application Publication
(10) Pub. No.: US 2005/0036785 A1
(43) Pub. Date: Feb. 17, 2005

(54) Optical transmission network

(76) Inventors: Ari Tervonen, Vantaa (FI); Olli-Pekka Hiironen, Helsinki (FI)

Correspondence Address: HARRINGTON & SMITH, LLP, 4 RESEARCH DRIVE, SHELTON, CT, 06484-6212, US

(21) Appl. No.: 10/499,412

(22) PCT Filed: Dec. 17, 2002
(86) PCT No.: PCT/IB02/05692

(30) Foreign Application Priority Data
Dec. 21, 2001 (FI) 20012570

(51) Int. Cl. H04J 14/00

(52) U.S. Cl. 398/49

(57) ABSTRACT

An optical fibre network comprises a hub, an optical router, and a plurality of optical network units (ONUs). In the downstream direction from the hub to the ONUs, the optical router receives channels having predefined wavelength ranges from a uni-directional input fibre and divides the channels so bi-directional input/output fibres receive at least one of the plurality of channels. In the upstream direction from the ONUs to the hub, the optical router receives the channels from the bi-directional input/output fibres, combines them, and outputs them to a uni-directional output fibre. For any particular channel, in the downstream direction it is routed to a first bi-directional input/output fibre and in the upstream it is routed from a second bi-directional input/output fibre different from the first bi-directional input/output fibre.

The invention relates to an optical transmission network. It is particularly, but not exclusively, related to a passive optical fibre network.

In order to provide broadband telecommunications, optical transmission systems have been developed. Typically such systems transmit optical signals along optical fibre in the wavelength range of 1300 to 1550 nm. In order to provide multiple access for a plurality of users, it has been proposed for optical transmission systems to use wavelength division multiple access (WDMA).

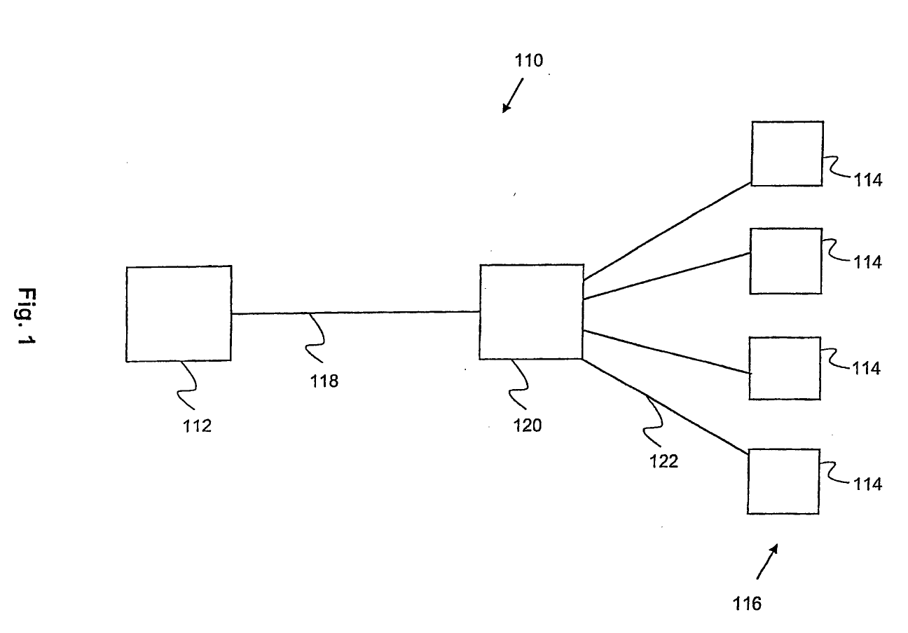

A prior art optical transmission system 110 is shown in FIG. 1. The system 110 comprises a central office (CO) or hub 112 connected to groups of users or optical network units (ONUs) 114. In this embodiment only one group 116 is shown although it will be understood that there would be a plurality of such groups. The hub 112 is connected by a common optical fibre 118 to a wavelength division multiplexer (WDM) 120. The users 114 are connected separately to the WDM 120 by respective optical fibres 122. The WDM 120 is said to be at a curb location.

A downstream direction is defined from the hub 112 to the users 114 and an upstream direction is defined from the users to the hub. Data traffic is transmitted both downstream and upstream to and from the users 114. The data traffic is in the form of modulated light as will be explained in the following.

Communication in the system occurs across a wavelength range, typically 1530 to 1565 nm. Each user is assigned a wavelength band, typically spaced by 0.8 nm, with which to communicate. The hub 112 is equipped with individual laser sources producing light at different wavelengths suitable for different users. In the downstream direction, the hub 112 forms data traffic by modulating data onto appropriate light wavelengths which are then transmitted down the common optical fibre 118 to the WDM 120. The WDM 120 separates the data traffic according to wavelength and then directs it to particular users 114.

For generation and transmission of data in the upstream direction, it is impractical to provide every user 114 with a laser source operating within its assigned wavelength band. Therefore, two arrangements have been proposed. In the first arrangement, spectral slicing is used, in which each user 114 has a broadband light source, from which a specific optical wavelength band is sliced to form a wavelength channel and then used in the network. Data traffic is formed by modulating data onto each wavelength channel either by switching the broadband light source on and off or by using an external modulator. In the second arrangement, a laser at the hub 112 transmits continuous wave (CW) light at appropriate wavelengths for each of the users 114 to use as a wavelength channel. Modulators located at the users 114 form data traffic by modulating data onto this CW light and send it to the WDM 120 by the respective optical fibres 122. Different wavelength channels from different users 114 are multiplexed together by the WDM 120 and transmitted together on the common optical fibre 118 to the hub 112. Such a system is disclosed in IEEE Photonics Technology Letters, November 1994, volume 6, number 11, pages 1365 to 1367.

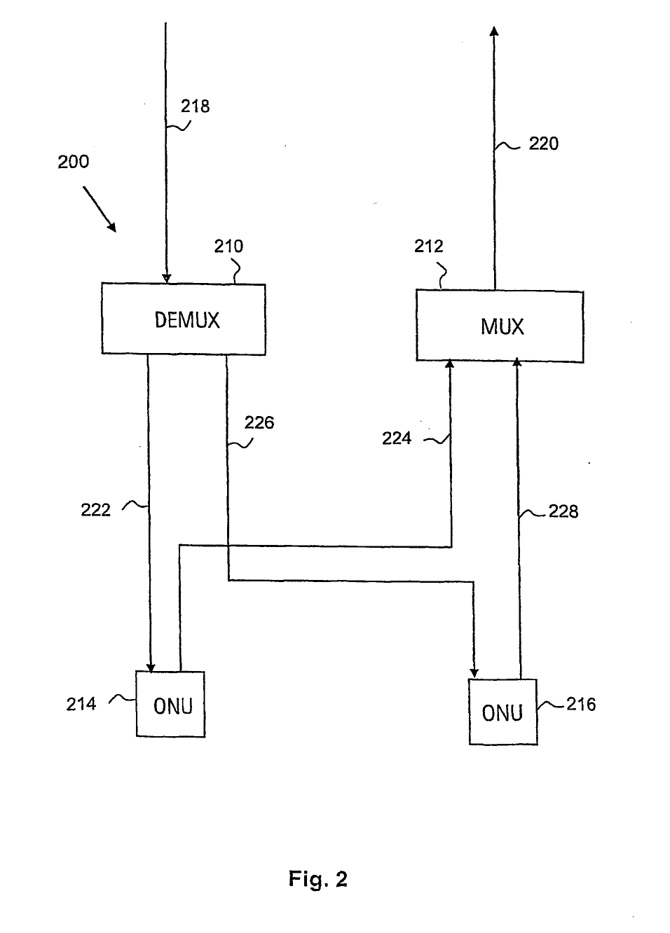

To achieve bi-directional transmission of data traffic between a WDM and users/ONUs, it is known in the prior art to provide respective ONUs with respective fibres in both upstream and downstream directions. This can be seen in FIG. 2 which shows an optical transmission system 200 having a multiplexer 210, a demultiplexer 212, a first ONU 214, and a second ONU 216. A downstream fibre 218 provides data traffic to the demultiplexer 210 and an upstream fibre 220 provides data traffic from the multiplexer 212. The first ONU 214 receives data traffic from the demultiplexer 210 from a downstream fibre 222 and sends data traffic to the multiplexer 212 along an upstream fibre 224. The second ONU 216 receives data traffic from the demultiplexer 210 from a downstream fibre 226 and sends data traffic to the multiplexer 212 along an upstream fibre 228. Downstream data traffic is transmitted along the downstream fibre 218 and demultiplexed in the demultiplexer 210. A first demultiplexed part of the downstream data traffic is transmitted along the downstream fibre 222 to the first ONU 214 and a second demultiplexed part of the downstream data traffic is transmitted along the downstream fibre 226 to the second ONU 216. Conversely, a first part of upstream data traffic is transmitted upstream from the first ONU 214 to the multiplexer 212 along the upstream fibre 224 and a second part of upstream data traffic is transmitted from the second ONU 216 to the multiplexer 212 along the upstream fibre 228. The multiplexer 212 multiplexes the first part of upstream data traffic and the second part of upstream data traffic and transmits the multiplexed upstream data traffic upstream from the multiplexer 212 along the upstream fibre 220.

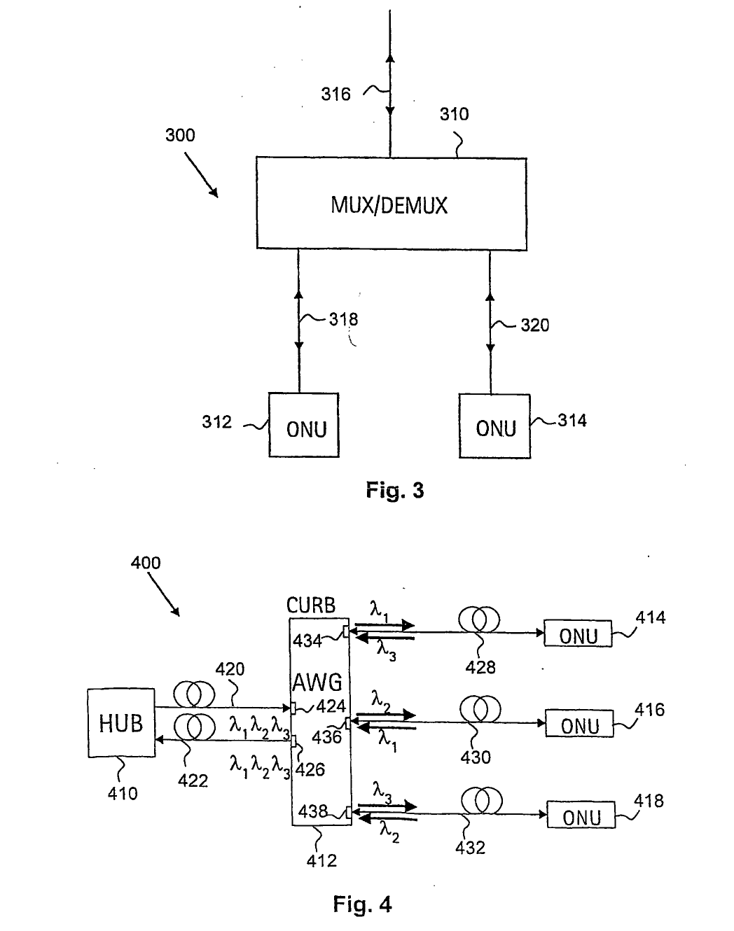

A disadvantage of the system of FIG. 2 is that it requires a separate fibre for each of the upstream and downstream directions. In order to deal with this disadvantage, the system of FIG. 3 has been proposed.

FIG. 3 shows a prior art optical transmission system 300 having a multiplexer/demultiplexer 310, a first ONU 312, and a second ONU 314. A bi-directional fibre 316 feeds downstream data traffic to and receives upstream data traffic from the demultiplexer 310. The first ONU 312 receives data traffic from and sends data traffic to the multiplexer/demultiplexer 310 along a bi-directional fibre 318. The second ONU 314 receives data traffic from and sends data traffic to the multiplexer/demultiplexer 310 along a bi-directional fibre 320.

There are several disadvantages with the system of FIG. 3. The multiplexer/demultiplexer 310 is a wavelength specific device and so the same wavelength is used in both directions in the fibres. Therefore, back-reflections from a connector, a splice, or any other discontinuity, can cause cross-talk between upstream and downstream data traffic. Another problem concerns use of optical amplifiers in such a system. Since optical amplifiers are generally uni-directional in operation, they cannot be used on bi-directional fibres such as bi-directional fibre 316.

According to a first aspect of the invention there is provided an optical transmission network comprising a hub, an optical router, and a plurality of network units located downstream of the optical router, the optical router having a hub-side and a network unit-side, on the hub-side the optical router receiving a plurality of channels having predefined distinct wavelength ranges from at least one uni-directional input and outputting the plurality of channels by at least one uni-directional output, on the network unit-side the optical router receiving/outputting the plurality of channels from/to a plurality of bi-directional inputs/outputs, wherein the optical router:
divides the plurality of channels from the at least one uni-directional input so that each of the plurality of bi-directional inputs/outputs receives at least one of the plurality of channels;
combines the plurality of channels received from the bi-directional inputs/outputs; and
routes each of the plurality of channels along light transmitting routes so that for any particular channel, in the downstream direction it is routed to a first bi-directional input/output and in the upstream direction it is routed from a second bi-directional input/output different from the first bi-directional input/output.

According to a second aspect of the invention, there is provided an optical router for connection between a hub and a plurality of network units located downstream of the optical router in an optical transmission network, the optical router having a hub-side and a network unit-side, on the hub-side the optical router receiving a plurality of channels having predefined distinct wavelength ranges from at least one uni-directional input and outputting the plurality of channels by at least one uni-directional output, on the network unit-side the optical router receiving/outputting the plurality of channels from/to a plurality of bi-directional inputs/outputs, wherein the optical router:
divides the plurality of channels from the at least one uni-directional input so that each of the plurality of bi-directional inputs/outputs receives at least one of the plurality of channels;
combines the plurality of channels received from the bi-directional inputs/outputs; and
routes each of the plurality of channels along light transmitting routes so that for any particular channel, in the downstream direction it is routed to a first bi-directional input/output and in the upstream direction it is routed from a second bi-directional input/output different from the first bi-directional input/output.

According to a third aspect of the invention, there is provided a method of interleaving a plurality of channels having predefined distinct wavelength ranges in an optical transmission network, the optical transmission network comprising a hub, an optical router, and a plurality of network units located downstream of the optical router, the optical router having a hub-side and a network unit-side, on the hub-side the optical router receiving the plurality of channels from at least one uni-directional input and outputting the plurality of channels by at least one uni-directional output, on the network unit-side the optical router receiving/outputting the plurality of channels from/to a plurality of bi-directional inputs/outputs, the method comprising the steps of:
the optical router dividing the plurality of channels from the at least one uni-directional input so that each of the plurality of bi-directional inputs/outputs receives at least one of the plurality of channels;
the optical router combining the plurality of channels received from the bi-directional inputs/outputs; and
the optical router routing each of the plurality of channels so that for any particular channel, in the downstream direction it is routed to a first bi-directional input/output and in the upstream direction it is routed from a second bi-directional input/output different from the first bi-directional input/output.

Preferably, different routing in the upstream and downstream directions enables the or each channel passing through the first bi-directional input/output in the downstream direction to be different to the or each channel passing through the first bi-directional input/output in the upstream direction. In this way, no two bi-directional inputs/outputs have an identical set of channels such that the same channel or channels travels or travel in the upstream direction and the same channel or channels travels or travel in the downstream direction.

In one embodiment, the optical router is a multiplexer/demultiplexer. Additionally, or alternatively, the optical router is an interleaver. It may be a combined interleaver/multiplexer/demultiplexer. In another embodiment, the optical router operates in conjunction with a multiplexer and a demultiplexer or a combined multiplexer/demultiplexer. The latter of these embodiments allows there to be distributed wavelength splitting functionality at the curb location. In yet another embodiment, a plurality of cascaded interleavers is used to provide a distributed optical router.

Preferably, the optical router has reciprocal routing in the upstream and downstream directions. This means that for any particular light transmitting route, any particular wavelength will have reciprocal routing in the upstream and downstream directions.

Preferably, for each network unit, different channels are used when transmitting and receiving data traffic in the upstream and downstream directions. This results in less cross-talk and back-reflection. Spectral filtering can be used to achieve even greater isolation.

Preferably, the optical transmission network is an optical fibre network. Most preferably, it is a passive optical network

Preferably, the optical router has light transmitting routes arranged between at least one input and inputs/outputs and light transmitting routes between inputs/outputs and at least one output such that, in the downstream direction, a channel is received by one input and output by a respective input/output, and, in the upstream direction, the channel is received by an input/output, the correspondence of the channel and the input/output for upstream being shifted relatively with respect to downstream, and output by at least one output.

Preferably, the optical router has light transmitting routes arranged between at least one input and inputs/outputs and light transmitting routes arranged between inputs/outputs and at least one output such that, in the downstream direction, a plurality of channels are received by at least one input and respective channels are output by respective adjacent inputs/outputs, and, in the upstream direction, the channels are received by respective inputs/outputs, the correspondence of each channel and its corresponding input/output for upstream being shifted relatively with respect to downstream, and output by at least one output.

Preferably, the correspondence between each channel and its corresponding input/output is shifted by the same amount. Preferably, the correspondence between each channel and its corresponding input/output is shifted by one so that it corresponds to an adjacent input/output for upstream.

In an embodiment in which the optical router comprises at least one input, at least one output, and inputs/outputs numbered 1 to x, the optical router has a circulation property such that for transmitting a particular channel, for downstream, there is a light transmitting route between the at least one input and an input/output x, and for upstream, there is a light transmitting route between an input/output 1 and the at least one output. In this way, for the particular channel to enter the optical router by the at least one input and to leave the optical router by the at least one output, it passes downstream though a first input/output and upstream through a second input/output where the first and second input/outputs are shifted from x to 1.

The optical router can be arranged so that the correspondence between each channel and its corresponding input/output for downstream and between each channel and its corresponding input/output for upstream is shifted by more than 1, that is the inputs/outputs used by a particular channel in the upstream and downstream directions are not adjacent.

Preferably, the optical router has light transmitting routes arranged between at least one input and inputs/outputs and light transmitting routes arranged between inputs/outputs and at least one output such that, in the downstream direction, a plurality of channels are received by at least one input and respective sub-groups of the channels are output by respective adjacent inputs/outputs, and, in the upstream direction, the sub-groups of the channels are received by respective inputs/outputs, the correspondence of each sub-group of the channels and its corresponding input/output for upstream being shifted relatively with respect to downstream, and output by at least one output.

Preferably, the optical router is an M×N router. In one embodiment it is a 2×N router. In another embodiment it is a 4×N router. It may be an arrayed waveguide grating (AWG).

In all aspects of the invention, the optical router may be a passive optical router. Most preferably it is a wavelength router which routes light depending on the wavelength of the light. It may be an interleaver.

Preferably, the downstream network units are optical network units (ONUs). It is to be understood that in one embodiment, the ONU is the location or functional unit or hardware (or any combination of these) at which conversion is made between data in optical and in electrical forms. In this way, it can represent the end of a passive optical network. Alternatively, the ONU may represent the transfer point to another optical network, for example an optical local area network (LAN).

The invention will now be described by way of example only with reference to the accompanying drawings in which:

FIG. 1 shows a WDMA system according to the prior art;

FIG. 2 shows another WDMA system according to the prior art;

FIG. 3 shows yet another WDMA system according to the prior art;

FIG. 4 shows a WDMA system according to the invention;

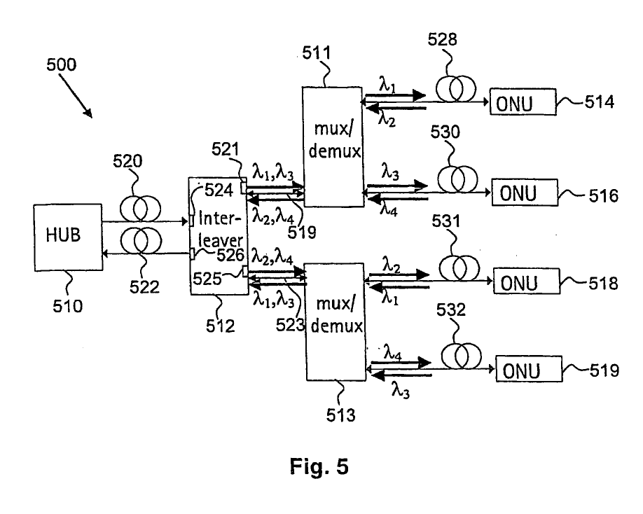

FIG. 5 shows another WDMA system according to the invention; and

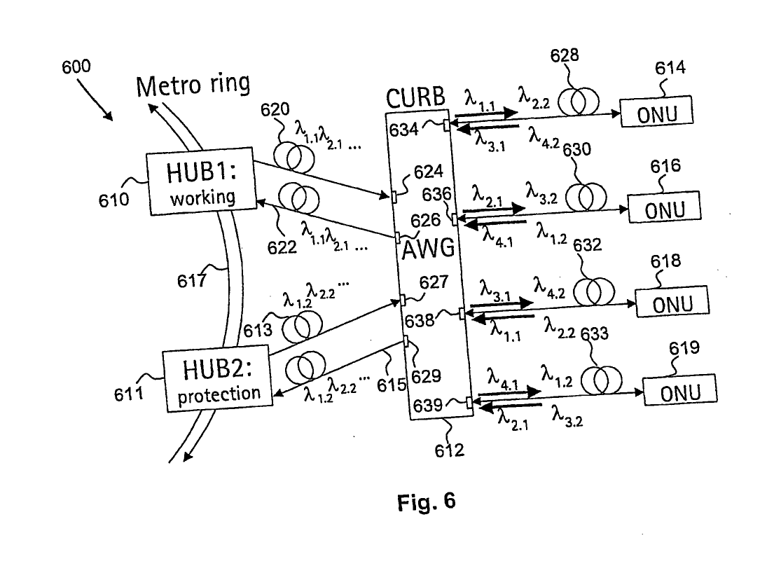

FIG. 6 shows yet another WDMA system according to the invention.

FIG. 4 shows a WDMA system 400 according to the invention comprising a hub 410, an optical router 412, a first optical network unit (ONU) 414, a second ONU 416, and a third ONU 418. The optical router 412 is at a curb location. It performs the functions of interleaving, multiplexing, and demultiplexing. In a preferred embodiment of the invention, the optical router 412 is an arrayed waveguide grating (AWG). Examples of AWGs can be seen in WO 98/54861 and WO 00/27057. In these publications, AWGs are referred to as waveguide phased arrays (WGAs).

In the downstream direction, the hub 410 is connected to the optical router 412 by a downstream uni-directional fibre 420 and in the upstream direction by an upstream uni-directional fibre 422. The downstream uni-directional fibre 420 and the upstream uni-directional fibre 422 are connected to the optical router 412 at respective uni-directional ports 424 and 426. The optical router 412 is connected to the first, second, and third ONUs 414, 416, and 418 by respective bi-directional fibres 428, 430, and 432. The bi-directional fibres 428, 430, and 432 are connected to the optical router 412 at respective bi-directional ports 434, 436, and 438. The bi-directional fibres 428, 430, and 432 feed downstream data traffic from the optical router 412 to respective ones of the ONUs and receive upstream data traffic from the ONUs to the optical router 412. The optical router 412 is a 2×N router.

A uni-directional port refers to a port through which data traffic passes only either in the upstream or in the downstream direction. A bi-directional port refers to a port through which data traffic passes both in the upstream and downstream directions.

The downstream uni-directional fibre 420 transmits data traffic on separate wavelength channels λ₁, λ₂, and λ₃ from the hub 410 to the optical router 412. The upstream uni-directional fibre 422 transmits data traffic on the same wavelength channels λ₁, λ₂, and λ₃ from the optical router 412 to the hub 410.

The ONUs 414, 416, and 418 each use different wavelength channels when transmitting and receiving data traffic in the upstream and downstream directions. The ONUs 414, 416, and 418 each have a unique upstream/downstream pair of wavelength channels. Therefore, as can be seen in FIG. 4, the first ONU 414 uses the wavelength channel λ₁ in the downstream direction and the wavelength channel λ₃ in the upstream direction, the second ONU 416 uses the wavelength channel λ₂ in the downstream direction and the wavelength channel λ₁ in the upstream direction, and the third ONU 418 uses the wavelength channel λ₃ in the downstream direction and the wavelength channel λ₂ in the upstream direction. In this way, in-band cross-talk between the upstream and downstream directions is avoided for each ONU for the connection between itself and the optical router 412.

In the downstream direction, the wavelength channel λ₁ entering the uni-directional port 424 is directed to the bi-directional port 434, the wavelength channel λ₂ entering the uni-directional port 424 is directed to the bi-directional port 436, and the wavelength channel λ₃ entering the uni-directional port 424 is directed to the bi-directional port 438. Additionally, the optical router 412 is configured so that, in the upstream direction, the wavelength channel λ₁ entering the bi-directional port 436 is directed to the uni-directional port 426, the wavelength channel λ₂ entering the bi-directional port 438 is directed to the uni-directional port 426, and the wavelength channel λ₃ entering the bi-directional port 434 is directed to the uni-directional port 426.

In general terms, data transmission in the upstream and downstream directions occurs as follows. In the downstream direction, the optical router outputs a plurality of wavelength channels λ₁, to λₙ (where n is an integer value representing the number of bi-directional ports the optical router has on the ONU-side) from a plurality of bi-directional ports P₁ to Pₙ respectively to bi-directional fibres connected to respective ONUs. In the upstream direction, the optical router receives the plurality of wavelength channels λ₁, to λₙ by the plurality of bi-directional ports P₁₊ₛ, to Pₙ, P₁ respectively from the bi-directional fibres connected to the ONUs (where s is an integer having a value from 0 to n and represents an interleaving shift associated with the interleaver/multiplexer/demultiplexer). It can be seen that in applying this general case to FIG. 4, s is 1, n is 3, and in the upstream direction, the optical router 412 receives the plurality of channels λ₁, to λ₃ by respective bi-directional ports P₂, P₃, and P₁ along respective bi-directional fibres 430, 432, and 428.

It is to be understood that the embodiment of an optical router having three ONUs is purely illustrative and embodiments having other numbers of ONUs are within the scope of the invention. This also applies to the number of bi-directional ports the ONU may have on its ONU-side. This can be seen in the following.

FIG. 5 shows another WDMA system 500 according to the invention comprising a hub 510, an interleaver 512, a first multiplexer/demultiplexer 511, a second multiplexer/demultiplexer 513, a first ONU 514, a second ONU 516, a third ONU 518, and a fourth ONU 519. The interleaver 512, the first multiplexer/demultiplexer 511, and the second multiplexer/demultiplexer 513 are at a curb location although they are not necessarily located at the same place at the curb location. In a preferred embodiment of the invention, the interleaver 512 is a 2×2 interleaver, and may be based on a Mach-Zehnder or Fabry-Perot interferometer, or some other suitable optical structure.

In the downstream direction, the hub 510 is connected to the interleaver 512 by a downstream uni-directional fibre 520 and in the upstream direction by an upstream uni-directional fibre 522. The downstream uni-directional fibre 520 and the upstream uni-directional fibre 522 are connected to the interleaver 512 at respective uni-directional ports 524 and 526. The first multiplexer/demultiplexer 511 is connected to the interleaver 512 by a bi-directional fibre 519 at a bi-directional port 521. The second multiplexer/demultiplexer 513 is connected to the interleaver 512 by a bi-directional fibre 523 at a bi-directional port 525. The first multiplexer/demultiplexer 511 is connected to the first and second ONUs 514 and 516 by respective bi-directional fibres 528 and 530. The second multiplexer/demultiplexer 513 is connected to the third and fourth ONUs 518 and 519 by respective bi-directional fibres 531 and 532. The bi-directional fibres 528, 530, 531, and 532 feed downstream data traffic from the first and second multiplexers/demultiplexers 511 and 513 to respective ones of the ONUs and receive upstream data traffic from respective ones of the ONUs to the first and second multiplexers/demultiplexers 511 and 513.

The downstream uni-directional fibre 520 transmits data traffic on separate wavelength channels λ₁, λ₂, λ₃, and λ₄, from the hub 510 to the interleaver 512. The upstream uni-directional fibre 522 transmits data traffic on the same wavelength channels λ₁, λ₂, λ₃, and λ₄ from the interleaver 512 to the hub 510.

The first and second multiplexers/demultiplexers 511 and 513 each use different wavelength channels when transmitting and receiving data traffic in the upstream and downstream directions. On the ONU-side of the multiplexer/demultiplexers, for each input/output port, two adjacent wavelength channels are used, one in the upstream direction and one in the downstream direction. The interleaver 512 controls which wavelength channels go to which multiplexer/demultiplexer. The first and second multiplexers/demultiplexers 511 and 513 each have a unique set of wavelength channels comprising an upstream pair and a downstream pair (the pairs being λ₁ and λ₃ and λ₂ and λ₄). In this embodiment, the term ‘unique’ applies to a combination of which wavelength channels are used and the direction, whether upstream or downstream, in which they are used. In this way, the same pair of wavelength channels (such as the pair λ₁ and λ₃ and the pair λ₂ and λ₄) is used both in the upstream and in the downstream directions. However, in another embodiment, the term ‘unique’ simply applies to which wavelength channels are used irrespective of the directions in which they are used.

Therefore, as can be seen in FIG. 5, the interleaver 512 uses the pair of wavelength channels λ₁ and λ₃ in the downstream direction and the pair of wavelength channels λ₂ and λ₄ in the upstream direction when communicating with the first multiplexer/demultiplexer 511 and uses the pair of wavelength channels λ₂ and λ₄ in the downstream direction and the pair of wavelength channels λ₁ and λ₃ in the upstream direction when communicating with the second multiplexer/demultiplexer 513. In this way, in-band cross-talk between the upstream and downstream directions is avoided in each connection between the interleaver 512 and the first and second multiplexers/demultiplexers 511 and 513.

Another way of looking at the invention is to consider the upstream/downstream pairs used by each ONU. Looking at the ONU 514 and the ONU 518, it can be seen that the same pairs of wavelength channels, λ₁ and λ₂, are used, but the respective directions taken by these channels, that is for the ONU 514 the wavelength channel λ₁ is used for downstream and the wavelength channel λ₃ is used for upstream and for the ONU 518 the wavelength channel λ₃ is used for downstream and the wavelength channel λ₁ is used for upstream, are reversed. The same applies to the other ONUs, that is, in this embodiment, the ONUs 516 and 519.

The ONUs 514, 516, 518, and 519 each use different wavelength channels when transmitting and receiving data traffic in the upstream and downstream directions. For the links between a particular multiplexer/demultiplexer and its respective ONUs, each of the respective ONUs has a unique upstream/downstream pair of wavelength channels. In this embodiment, the term ‘unique’ applies simply to which wavelength channels are used. However, in another embodiment, it could also apply not only to which wavelength channels are used but also to the direction, whether upstream or downstream, in which they are used. In this way, the same pair of wavelength channels could be used both in the upstream and in the downstream directions

Therefore, as can be seen in FIG. 5, the first ONU 514 uses the wavelength channel λ₁ in the downstream direction and the wavelength channel λ₂ in the upstream direction, the second ONU 516 uses the wavelength channel λ₃ in the downstream direction and the wavelength channel λ₄ in the upstream direction, the third ONU 518 uses the wavelength channel λ₂ in the downstream direction and the wavelength channel λ₁ in the upstream direction, and the fourth ONU 519 uses the wavelength channel λ₄ in the downstream direction and the wavelength channel λ₃ in the upstream direction. In this way, in-band cross-talk between the upstream and downstream directions is avoided for each ONU for the connection between itself its respective multiplexer/demultiplexer.

In the downstream direction, the wavelength channels λ₁ and λ₃ entering the uni-directional port 524 are directed to the bi-directional port 521, and the wavelength channels λ₂ and λ₄ entering the uni-directional port 524 are directed to the bi-directional port 525. Additionally, the interleaver 512 is configured so that, in the upstream direction, the wavelength channels λ₂ and λ₄ entering the bi-directional port 521 are directed to the uni-directional port 526, and the wavelength channels λ₁ and λ₃ entering the bi-directional port 525 are directed to the uni-directional port 526.

It should be noted that although reference is made to pairs of wavelength channels passing along the bi-directional fibres between the multiplexers/demultiplexers and the ONUs in the embodiment of FIG. 5, in a modification of this embodiment, more than two channels may pass along the bi-directional fibres. Equally, a set of more than two wavelength channels may pass in the upstream direction and a set of more than two channels may pass in the downstream direction between the interleaver and the multiplexers/demultiplexers. All that is required is that each multiplexer/demultiplexer used has a unique upstream set of wavelength channels and a unique downstream set of wavelength channels. The term ‘unique’ may apply simply to which wavelength channels are used to or it may apply to a combination of which wavelength channels are used and the direction, whether upstream or downstream, in which they are used.

In general terms, data transmission in the upstream and downstream directions occurs as follows. In the downstream direction, the interleaver outputs a plurality of pairs of wavelength channels λ₁ and λ₁₊ₘ, to λₙ₋ₘ and λₙ (where n is an integer value) from a plurality of bi-directional ports P₁ to Pₘ respectively to bi-directional fibres connected to respective ONUs. In the upstream direction, the interleaver receives the plurality of pairs of wavelength channels λ₁ and λ₁₊ₘ, to λₙ₋ₘ and λₙ by the plurality of bi-directional ports P₁₊ₛ to Pₙ, P₁ respectively from the bi-directional fibres connected to the ONUs (where s is an integer having a value from 0 to m and represents an interleaving shift associated with the interleaver). It can be seen that in applying this general case to FIG. 5, s is 1, n is 4, and m Is 2, and, in the upstream direction, the interleaver 512 receives the pair of wavelength channels λ₂ and λ₄ at bi-directional port 521 and the pair of wavelength channels λ₁ and λ₃ at bi-directional port 525, and, in the downstream direction, the first multiplexer/demultiplexer 511 receives the pair of wavelength channels λ₁ and λ₃, from bi-directional port 521 and the second multiplexer/demultiplexer 513 receives the pair of wavelength channels λ₂ and λ₄ from bi-directional port 525.

The embodiment of FIG. 5 may be suitable when there is distributed wavelength splitting functionality at the curb. In FIG. 4, since an AWG optical router is used, it is located at one discrete place in the network. In FIG. 5, since an optical router is provided which is built out of separate modules (the interleaver 512, the first multiplexer/demultiplexer 511, and the second multiplexer/demultiplexer 513), the functionality can be distributed at different locations in the network.

The interleaver is a 2×2 router. The multiplexers/demultiplexers 511 and 513 each multiplex/demultiplex two pairs of wavelength channels and are capable of separating the wavelength channels λ₁ and λ₂ from the wavelength channels λ₃ and λ₄. In addition, the ONUs each use a different wavelength channel in the upstream and downstream directions, and the interleaver mixes the routing of the wavelength channels in order that ONUs each have a unique pair of wavelength channels in the upstream and downstream directions.

It is to be understood that other embodiments of the invention can use an interleaver having other than two bi-directional ports on its ONU-side.

The FIG. 5 embodiment having four 4 ONUs can be expressed in general terms as a system having N=2K ONUs. The interleaver of such a generalised system divides the wavelength channels received into sets of odd and even wavelength channels in the downstream direction and combines them, in a reciprocal manner, in the upstream direction. The spectral passbands of the multiplexers/demultiplexers are wide enough to handles adjacent wavelength channels in each of the sets of the odd and even wavelength channels.

In the embodiments of FIGS. 4 and 5, it is preferred for each ONU to use a broadband source to generate the light it uses for transmission. Therefore, a particular ONU transmits data traffic across a relatively wide wavelength range and only part of this range (representing the wavelength channel of each ONU) is transmitted to the appropriate output of the optical router 412 or interleaver 512 to enable it to be routed to the hub. This occurs naturally if the optical router 412 or interleaver 512 has variable transmissivity over its operational wavelength range so that there is a wavelength-dependent correspondence between input and output ports. In this way, it can be seen that the optical router 412 or the interleaver 512 in combination with the multiplexer/demultilplexer 511 and the multiplexer/demultilplexer 513 acts as a spectral slicer for defining wavelength channels.

FIG. 6 shows yet another WDMA system 600 according to the invention comprising a first hub 610, a second hub 611, an optical router 612, a first ONU 614, a second ONU 616, a third ONU 618, and a fourth ONU 619. The optical router 612 is at a curb location. It performs the functions of interleaving, multiplexing, and demultiplexing. In a preferred embodiment, the optical router 612 is an arrayed waveguide grating. The first and second hubs are connected by a metro ring 617 or any connecting network. Thus, whilst the typical topology is a ring, any other suitable topology, such as a tree topology, may be used.

In the downstream direction, the first hub 610 is connected to the optical router 612 by a downstream uni-directional fibre 620 and by an upstream uni-directional fibre 622 in the upstream direction. Likewise, the second hub 611 is connected to the optical router 612 by a downstream uni-directional fibre 613 and by an upstream uni-directional fibre 615 in the upstream direction. The downstream uni-directional fibres 620 and 613 and the upstream uni-directional fibres 622 and 615 are connected to the optical router 612 at respective uni-directional ports 624 and 627 and 626 and 629. The optical router 612 is connected to the first, second, third, and fourth ONUs 614, 616, 618, and 619 by respective bi-directional fibres 628, 630, 632, and 633. The bi-directional fibres 628, 630, 632, and 633 are connected to the optical router 612 at respective bi-directional ports 634, 636, 638, and 639. The bi-directional fibres 628, 630, 632, and 633 feed downstream data traffic from the optical router 612 to respective ones of the ONUs and receive upstream data traffic from the ONUs 614, 616, 618, and 619 to the optical router 612. Accordingly, it can be understood that the optical router 612 is a 4×4 router.

The first hub 610 is a working hub and the second hub 611 is an alternative or protection hub which can be used as a reserve or a back-up hub. In usual working, data traffic passes between the first hub 610 and the ONUs 614, 616, 618, and 619. The reserve connection from the second hub 611 is idle. If it is not possible to transmit data traffic from the first hub 610 to the ONUs 614, 616, 618, and 619 (for example because of a fault or because of maintenance), the connection to the first hub 610 is disabled and the second hub 611 is used to transmit data traffic to the ONUs 614, 616, 618, and 619.

The downstream uni-directional fibre 620 transmits data traffic on separate wavelength channels λ_{1.1}, λ_{2.1}, λ_{3.1}, and λ_{4.1} from the first hub 610 to the optical router 612 and the upstream uni-directional fibre 622 transmits data traffic on the same wavelength channels λ_{1.1}, λ_{2.1}, λ_{3.1}, and λ_{4.1} from the optical router 612 to the first hub 610. The downstream uni-directional fibre 613 transmits data traffic on separate wavelength channels λ_{1.2}, λ_{2.2}, λ_{3.2}, and λ_{4.2} from the second hub 611 to the optical router 612 and the upstream uni-directional fibre 615 transmits data traffic on the same wavelength channels λ_{1.2}, λ_{2.2}, λ_{3.2}, and λ_{4.2} from the optical router 612 to the second hub 611.

The ONUs 614, 616, 618, and 619 each use different wavelength channels when transmitting and receiving data traffic in the upstream and downstream directions. The ONUs 614, 616, 618, and 619 each have a unique upstream/downstream pair of wavelength channels. Therefore, as can be seen in FIG. 6, the first ONU 614 uses the wavelength channels λ_{1.1} and λ_{2.2} in the downstream direction and the wavelength channels λ_{3.1} and λ_{4.2} in the upstream direction, the second ONU 616 uses the wavelength channels λ_{2.1} and λ_{3.2} in the downstream direction and the wavelength channels λ_{4.1} and λ_{1.2} in the upstream direction, the third ONU 418 uses the wavelength channels λ_{3.1} and λ_{4.2} in the downstream direction and the wavelength channels λ_{1.1} and λ_{2.2} in the upstream direction, and the fourth ONU 619 uses the wavelength channels λ_{4.1} and λ_{1.2} in the downstream direction and the wavelength channels λ_{2.1} and λ_{3.2} in the upstream direction. In this way, in-band cross-talk between the upstream and downstream directions is avoided for each ONU for the connection between itself and the optical router 612.

The pairs of wavelength channels in the upstream direction preferably originate from a broadband source in each of the ONUs 614, 616, 618, and 619. Therefore, rather than the ONUs 614, 616, 618, and 619 transmitting data traffic on two distinct wavelength channels, they simply transmit across a relatively wide wavelength range and part of this range is separated by the optical router 612 and routed to the first hub 610 so that it represents the wavelength channel λ_{1.1} and another part of this range is separated by the optical router 612 and routed to the second hub 611 so that it represents the wavelength channel λ_{1.2}. In this way, it can be seen that the optical router 612 acts as a spectral slicer for defining wavelength channels. It is to be understood that in this embodiment, each of the ONUs 614, 616, 618, and 619 transmits the same data traffic over the whole of its wavelength range and so identical data traffic is transmitted over the wavelength channel λ_{1.1} and the wavelength channel λ_{1.2}. Since only one hub will be working at one time, one of the wavelength channels is rejected.

Looking now at the first hub 610, in the downstream direction, the wavelength channel λ_{1.1} entering the uni-directional port 624 is directed to the bi-directional port 634, the wavelength channel λ_{2.1} entering the uni-directional port 624 is directed to the bi-directional port 636, the wavelength channel λ_{3.1} entering the uni-directional port 624 is directed to the bi-directional port 638, and the wavelength channel λ_{4.1} entering the uni-directional port 624 is directed to the bi-directional port 639. Additionally, the optical router 612 is configured so that, in the upstream direction, the wavelength channel λ_{1.1} entering the bi-directional port 638 is directed to the uni-directional port 626, the wavelength channel λ_{2.1} entering the bi-directional port 639 is directed to the uni-directional port 626, the wavelength channel λ_{3.1} entering the bi-directional port 634 is directed to the uni-directional port 626, and the wavelength channel λ_{4.1} entering the bi-directional port 636 is directed to the uni-directional port 626.

Looking now at the second hub 611, in the downstream direction, the wavelength channel λ_{1.2} entering the uni-directional port 627 is directed to the bi-directional port 634, the wavelength channel λ_{2.2} entering the uni-directional port 627 is directed to the bi-directional port 636, the wavelength channel λ_{3.2} entering the uni-directional port 627 is directed to the bi-directional port 638, and the wavelength channel λ_{4.2} entering the uni-directional port 627 is directed to the bi-directional port 639. Additionally, the optical router 612 is configured so that, in the upstream direction, the wavelength channel λ_{1.2} entering the bi-directional port 636 is directed to the uni-directional port 629, the wavelength channel λ_{2.2} entering the bi-directional port 638 is directed to the uni-directional port 629, the wavelength channel λ_{3.2} entering the bi-directional port 639 is directed to the uni-directional port 629, and the wavelength channel λ_{4.2} entering the bi-directional port 634 is directed to the uni-directional port 629.

In general terms, data transmission in the upstream and downstream directions occurs as follows. In the downstream direction, for each hub h, the optical router outputs a plurality of wavelength channels λ_{1.h} to λ_{n.h} (where n is an integer value representing the number of bi-directional ports the optical router has on the ONU side and h is either 1 or 2 depending on which hub is being considered) from a plurality of bi-directional ports P₁ to Pₙ respectively to bi-directional fibres connected to respective ONUs. In the upstream direction, the optical router receives the plurality of wavelength channels λ_{1.h} to λ_{n.h} by the plurality of bi-directional ports P₁₊ₛ to Pₙ, P₁ respectively from the bi-directional fibres connected to the ONUs (where s is an integer having a value from 0 to n and represents an interleaving shift associated with the interleaver/multiplexer/demultiplexer). It can be seen that in applying this general case to FIG. 6, s is 1, n is 4, and in the upstream direction, the optical router receives the plurality of channels λ_{1.h} to λ_{3.h} by respective bi-directional ports P₂, P₃, P₄, and P₁ from the bi-directional fibres.

In common with the embodiments described in relation to FIGS. 4 and 5, the optical router 612 has variable transmissivity over its operational wavelength range so that there is a wavelength-dependent correspondence between input and output ports. In this way, it can be seen that the optical router 612 acts as a spectral slicer for defining wavelength channels.

The WDMA system 600 of FIG. 6 can be modified so that the first hub 610 and the second hub 611 work at the same time to transmit different data traffic. In a first modification, the ONUs are each equipped with a first transmitter/receiver pair and a second transmitter/receiver pair. The transmitter/receiver pairs operate at distinct wavelength channels and the ONUs are configured such that they can transmit and receive data traffic separately on each channel. In a second, further, modification, each ONU is equipped with a single transmitter and a pair of receivers and is configured so that it can transmit data traffic on one wavelength channel and receive it on a pair of wavelength channels. This embodiment is particularly suitable if used in a data transmission system in which much more data traffic is transmitted downstream than upstream. An example of such a system is a cable TV system. An advantage of the first and second modifications is that they allow for even greater savings in the amount of fibre which is required.

Although wavelength channels have been given sequential numbering, for example λ₁, λ₂, λ₃, and λ₄, adjacent wavelength channels in terms of numbering are not necessarily adjacent in terms of wavelength. For example, it is preferred for the wavelength channels used in each bi-directional fibre, whether this is a plurality of wavelength channels in one direction or a wavelength channel in upstream and a wavelength channel in downstream, to be widely separated in order to minimise in-band cross-talk and back-reflections and to provide easier wavelength channel separation at the ONUs.

In general terms, the invention can be expressed to be an optical transmission network comprising a hub, an optical router, and N ONUs. The hub and the optical router are connected by uni-directional fibres and the optical router and the ONUs are connected by bi-directional fibres. The optical router has a hub-side and an ONU-side. On the hub-side the optical router has M uni-directional ports indexed by i=1, . . . , M, in the case of at least one of the ports to receive a plurality of channels having predefined distinct wavelength ranges and in the case of at least another of the ports to output the plurality of channels. On the ONU-side the optical router has N bi-directional inputs/output ports indexed by j=1, . . . , N to receive/output the plurality of channels. Connections of the optical router between the hub-side and the ONU-side between respective ports i and j are λᵢⱼ, in the downstream direction, a downstream uni-directional fibre from the hub connected to the optical router port i=1, is connected to all ONUs in the wavelength set λᵢⱼ, j=11, . . . , N. In the upstream direction, an upstream uni-directional fibre from hub connected to the optical router port i=2, is connected to all ONUs in the wavelength set λ₂ⱼ, j=1, . . . , N. For respective bi-directional fibres to each of the ONUs, the wavelength λ₁ⱼ in the downstream direction and the wavelength λ₂ⱼ, in the upstream direction are different. In a specific embodiment of the invention, the optical router is wavelength dependent in order to provide the connections between the hub-side and the ONU side. The wavelength sets in the upstream and downstream directions are typically (but not necessarily) in the same total spectral range and may partially and totally overlap.

In an embodiment of this invention, on the hub-side, the optical router has at least one additional pair of ports, indexed by numerals 3 and 4, which are used for connecting to at least one additional, protection, hub. Again, in common with the embodiment described in the foregoing, an additional hub is present to provide extra capacity and both hubs (or in fact more than two hubs) transmit different data simultaneously In the downstream direction, a downstream uni-directional fibre from the protection hub connected to the optical router port i=3, is connected to all ONUs in the wavelength set λ₃ⱼ, j=1, . . . , N. In the upstream direction, an upstream uni-directional fibre from hub connected to the optical router port i=2, is connected to all ONUs in the wavelength set λ₄ⱼ, j=1, . . . , N. Therefore, each ONU has an additional hub connection for protection. The two connections are provided by two downstream wavelengths λ₁ⱼ and λ₃ⱼ and two upstream wavelength λ₂ⱼ and λ₄ⱼ. The system is arranged such that data traffic from one hub is transmitted along a bi-directional fibre between the optical router and the ONUs on different wavelength channels in upstream and downstream directions.

In the downstream direction, each hub uses its own separate transmitter. The protection hub can be off-state, that is it does not transmit, until it is needed. Alternatively, both hubs can transmit data at the same time. In this way, the protection hub can transmit additional downstream broadcast traffic to the ONUs.

Rather than being used as an alternative or protection hub, the second hub may be used for broadcasting data downstream to the ONUs. In a case in which the second hub (whether it is serving as a protection hub or as a second broadcasting hub) has a single broadband optical transmitter covering the full range of downstream wavelength, the network spectrally slices the data to be delivered to all ONUs.

In the upstream direction, each ONU has a broadband transmitter sending data at both upstream wavelength channels. In this way, a single transmitter sends the same data to both hubs, and an additional upstream protection connection is always present. The upstream wavelength channels are spectrally sliced in some appropriate way, for example by the wavelength routing operation of the optical router.

In summary, the invention is a network of a hub, a wavelength router, and N ONUs. The ONUs are each connected to the wavelength router with respective single fibres having bi-directional traffic at different wavelengths. The wavelength router is connected to the hub by separate fibres in the upstream and downstream directions so that from each ONU, upstream and downstream wavelengths are routed to these separate fibres, respectively.

According to the foregoing embodiments of the invention, a single fibre between the curb and each ONU saves fibre and provides for simple connection at the ONUs. A fibre pair is used between the hub and the curb to separate the upstream and downstream directions. Duplication of fibre between these locations is not a critical issue.

In any or in all of the embodiments described in the foregoing, separating upstream and downstream data traffic at each ONU can be achieved by using a directional coupler.

The invention is applicable in an optical WDMA communications system such as that described in relation to FIG. 1 in which each user 114 has a broadband light source it spectrally slices to provide its assigned wavelength channel which it uses to transmit data traffic. In an alternative embodiment, the system has wavelength-specific narrowband sources at both the hub and the ONUs.

Particular implementations and embodiments of the invention have been described. For example, the ports on the ONU-side of the optical router or optical router do not have to be uni-directional. So long as data traffic is only sent through such ports in one direction, they can be bi-directional, that is they would be uni-directional in terms of operation rather than in terms of implementation. It is clear to a person skilled in the art that the invention is not restricted to details of the embodiments presented above, but that it can be implemented in other embodiments using equivalent means without deviating from the characteristics of the invention. The scope of the invention is only restricted by the attached patent claims.

1. An optical transmission network comprising a hub, an optical router, and a plurality of network units located downstream of the optical router, the optical router having a hub-side and a network unit-side, on the hub-side the optical router receiving a plurality of channels having predefined distinct wavelength ranges from at least one uni-directional input and outputting the plurality of channels by at least one uni-directional output, on the network unit-side the optical router receiving/outputting the plurality of channels from/to a plurality of bi-directional inputs/outputs, wherein the optical router:
divides the plurality of channels from the at least one uni-directional input so that each of the plurality of bi-directional inputs/outputs receives at least one of the plurality of channels;
combines the plurality of channels received from the bi-directional inputs/outputs; and
routes each of the plurality of channels along light transmitting routes so that for any particular channel, in the downstream direction it is routed to a first bi-directional input/output and in the upstream direction it is routed from a second bi-directional input/output different from the first bi-directional input/output.

2. An optical transmission network according to claim 1 in which the optical router combines the plurality of channels received from the bi-directional inputs/outputs and provides them to the at least one uni-directional output.

3. An optical transmission network according to claim 1 in which different routing in the upstream and downstream directions enables the or each channel passing through the first bi-directional input/output in the downstream direction to be different to the or each channel passing through the first bi-directional input/output in the upstream direction.

4. An optical transmission network according to claim 1 in which the optical router comprises a multiplexer/demultiplexer.

5. An optical transmission network according to claim 1 in which the optical router comprises a cascade of interleavers.

6. An optical transmission network according to claim 1 in which the optical router operates in conjunction with a multiplexer and a demultiplexer or a combined multiplexer/demultiplexer.

7. An optical transmission network according to claim 1 in which, for each downstream network unit, different channels are used when transmitting and receiving data traffic in the upstream and downstream directions.

8. An optical transmission network according to claim 1 comprising an optical fibre network.

9. An optical transmission network according to claim 1 comprising a passive optical network.

10. An optical transmission network according to claim 1 in which the optical router has light transmitting routes arranged between at least one input and inputs/outputs and light transmitting routes arranged between inputs/outputs and at least one output such that, in the downstream direction, a plurality of channels are received by at least one input and respective channels are output by respective adjacent inputs/outputs, and, in the upstream direction, the channels are received by respective inputs/outputs, the correspondence of each channel and its corresponding input/output for upstream being shifted relatively with respect to downstream, and output by at least one output.

11. An optical transmission network according to claim 10 in which the correspondence between each channel and its corresponding input/output for downstream and between each channel and its corresponding input/output for upstream is shifted by the same amount.

12. An optical transmission network according to claim 10 in which the correspondence between each channel and its corresponding input/output for downstream and between each channel and its corresponding input/output for upstream is shifted by one.

13. An optical transmission network according to claim 10 in which the correspondence between each channel and its corresponding input/output for downstream and between each channel and its corresponding input/output for upstream is shifted by more than one.

14. An optical transmission network according to claim 1 in which the optical router has light transmitting routes arranged between at least one input and inputs/outputs and light transmitting routes arranged between inputs/outputs and at least one output such that, in the downstream direction, a plurality of channels are received by at least one input and respective sub-groups of the channels are output by respective adjacent inputs/outputs, and, in the upstream direction, the sub-groups of the channels are received by respective inputs/outputs, the correspondence of each sub-group of the channels and its corresponding input/output for upstream being shifted relatively with respect to downstream, and output by at least one output.

15. An optical transmission network according to claim 14 in which the correspondence between each sub-group of channels and its corresponding input/output for downstream and between each sub-group of channels and its corresponding input/output for upstream is shifted by the same amount.

16. An optical transmission network according to claim 14 in which the correspondence between each sub-group of channels and its corresponding input/output for downstream and between each sub-group of channels and its corresponding input/output for upstream is shifted by one.

17. An optical transmission network according to claim 14 in which the correspondence between each sub-group of channels and its corresponding input/output for downstream and between each sub-group of channels and its corresponding input/output for upstream is shifted by more than one.

18. An optical transmission network according to claim 1 in which the optical router comprises at least one input, at least one output, and inputs/outputs numbered 1 to x, and has a circulation property such that for transmitting a particular channel, for downstream there is a light transmitting route between the at least one input and an input/output x, and for upstream there is a light transmitting route between an input/output 1 and the at least one output.

19. An optical transmission network according to claim 1 in which the optical router comprises an M×N router.

20. An optical transmission network according to claim 1 in which the optical router comprises an arrayed waveguide grating (AWG).

21. An optical transmission network according to claim 1 in which optical transmission terminates in the network units.

22. An optical transmission network according to claim 1 in which the network units comprise optical network units (ONUs).

23. An optical router (for connection between a hub and a plurality of network units located downstream of the optical router in an optical transmission network 40, the optical router having a hub-side and a network unit-side, on the hub-side the optical router receiving a plurality of channels having predefined distinct wavelength ranges from at least one uni-directional input and outputting the plurality of channels by at least one uni-directional output, on the network unit-side the optical router receiving/outputting the plurality of channels from/to a plurality of bi-directional inputs/outputs, wherein the optical router: divides the plurality of channels from the at least one uni-directional input so that each of the plurality of bi-directional inputs/outputs receives at least one of the plurality of channels; combines the plurality of channels received from the bi-directional inputs/outputs; and routes each of the plurality of channels along light transmitting routes so that for any particular channel, in the downstream direction it is routed to a first bi-directional input/output and in the upstream direction it is routed from a second bi-directional input/output different from the first bi-directional input/output.

24. A method of interleaving a plurality of channels having predefined distinct wavelength ranges in an optical transmission network, the optical transmission network comprising a hub, an optical router, and a plurality of network units located downstream of the optical router, the optical router having a hub-side and a network unit-side, on the hub-side the optical router receiving the plurality of channels from at least one uni-directional input and outputting the plurality of channels by at least one uni-directional output, on the network unit-side the optical router receiving/outputting the plurality of channels from/to a plurality of bi-directional inputs/outputs, the method comprising the steps of:
the optical router dividing the plurality of channels from the at least one uni-directional input so that each of the plurality of bi-directional inputs/outputs receives at least one of the plurality of channels;
the optical router combining the plurality of channels received from the bi-directional inputs/outputs; and
the optical router routing each of the plurality of channels so that for any particular channel, in the downstream direction it is routed to a first bi-directional input/output and in the upstream direction it is routed from a second bi-directional input/output different from the first bi-directional input/output.
